(19) United States
(12) Patent Application Publication
(10) Pub. No.: US 2026/0155475 A1
(43) Pub. Date: Jun. 4, 2026

(54) THERMAL MANAGEMENT IN BATTERY CELL

(71) Applicant: GM Global Technology Operations LLC, Detroit, MI (US)

(72) Inventors: Zhenwen Hu, Shanghai (CN); Ryan Patrick Hickey, Austin, TX (US); Jian Yao, Shanghai (CN); Chengwu Duan, Shanghai (CN); Yusheng Zou, Shanghai (CN)

(21) Appl. No.: 18/982,760

(22) Filed: Dec. 16, 2024

(30) Foreign Application Priority Data
Dec. 3, 2024 (CN) 202411764061.5

(51) Int. Cl. H01M 10/63; H01M 10/613; H01M 10/625; H01M 10/6557

(52) U.S. Cl. CPC H01M 10/63; H01M 10/613; H01M 10/625; H01M 10/6557

(57) ABSTRACT

A cooling system for a battery pack includes a plurality of thermal cooling channels, an inlet flow channel in fluid communication with each one of the plurality of thermal cooling channels, an exit flow channel in fluid communication with each one of the plurality of thermal cooling channels; and a varistor, in communication with a controller, positioned on one of the plurality of thermal cooling channels and adapted to generate a force change signal in response to pressure increase within a thermal cooling channel and to communicate the force change signal to the controller, the controller adapted to receive the force change signal, identify the occurrence of battery cell venting and a thermal propagation event based on the force change signal, and alter flow of coolant through the plurality of thermal cooling channels.

### INTRODUCTION

The present disclosure relates to a battery cell cooling system within a rechargeable battery pack of an electric vehicle having channels adapted to provide a supply of cooling fluid to and from thermal cooling channels.

Thermal propagation is a significant risk present in batteries. It occurs due to a battery cell failure of some kind. Thermal cooling channels provide cooling to the battery pack to alleviate thermal propagation wherein the temperature of one battery cell increases rapidly and causes the temperature of an adjacent battery cell to also increase rapidly. Early detection of a thermal propagation event allows the cooling system within a battery pack to adapt in response to the thermal propagation event.

Thus, while current battery packs achieve their intended purpose, there is a need for a new and improved cooling system for a battery pack adapted to detect a thermal propagation event and respond with actions adapted to provide additional cooling to battery cells experiencing the thermal propagation event.

### SUMMARY

According to several aspects of the present disclosure, a cooling system for a rechargeable battery pack includes a plurality of thermal cooling channels adapted to be positioned between adjacent rows of individual battery cells of the battery pack, an inlet flow channel in fluid communication with each one of the plurality of thermal cooling channels and adapted to connect to a supply of coolant and provide a flow path between the supply of coolant and each one of the plurality of thermal cooling channels, an exit flow channel in fluid communication with each one of the plurality of thermal cooling channels and adapted to provide a flow path for coolant to exit each one of the plurality of thermal cooling channels, and a varistor, in communication with a controller, positioned on one of the plurality of thermal cooling channels and adapted to generate a force change signal in response to pressure increase within the one of the plurality of thermal cooling channels and to communicate the force change signal to the controller, the controller adapted to receive the force change signal from the varistor, identify the occurrence of battery cell venting and a thermal propagation event based on the force change signal, and alter flow of coolant through the plurality of thermal cooling channels in response to the identification of battery cell venting and the thermal propagation event.

According to another aspect, the plurality of thermal cooling channels is divided into a plurality of modules, each module including a portion of the plurality of thermal cooling channels positioned between adjacent structural cross-members of the battery pack, the cooling system including a plurality of varistors in communication with the controller, one of the plurality of varistors positioned on a one of the plurality of thermal cooling channels within each one of the modules.

According to another aspect, the controller is further adapted to receive a force change signal from one of the plurality of varistors, identify the occurrence of battery cell venting and a thermal propagation event within a one of the plurality of modules where the one of the plurality of varistors is positioned, and alter flow of coolant through the plurality of thermal cooling channels by increasing the flow of coolant through the thermal cooling channels of the one of the plurality of modules in response to the identification of battery cell venting and the thermal propagation event therein.

According to another aspect, when altering the flow of coolant through the plurality of thermal cooling channels by increasing the flow of coolant through the thermal cooling channels of the one of the plurality of modules, the controller is adapted to at least one of increase total flow of coolant within the coolant system, and divert flow of coolant within the coolant system, selectively increasing the flow of coolant through the thermal cooling channels of the one of the plurality of modules and reducing the flow of coolant through remaining ones of the plurality of modules.

According to another aspect, the exit flow channel comprises a plurality of exit flow channel segments and a main exit channel, and wherein one exit flow channel segment interconnects the plurality of thermal cooling channels within each one of the modules, each exit flow channel segment including a vertical connector interconnecting the exit flow channel to the main exit channel, wherein, for each module, coolant flows from the plurality of thermal cooling channels into the exit flow channel segment and through the vertical connector upward to the main exit channel, the vertical connector of each of the plurality of exit flow channel segments including a selectively variable valve, wherein the cross-sectional area of a flow path of the vertical connector is selectively and independently variable.

According to another aspect, when selectively increasing the flow of coolant through the thermal cooling channels of the one of the plurality of modules and reducing the flow of coolant through the remaining ones of the plurality of modules, the controller is adapted to at least one of actuate the selectively variable valve within the vertical connector of the exit flow channel segment within the one of the plurality of modules, increasing the cross-sectional area of the flow path through the vertical connector, and actuate the selectively variable valve within the vertical connector of the exit flow channel segment within each of the remaining ones of the plurality of modules, decreasing the cross-sectional area of the flow path.

According to another aspect, each variable valve is adapted to prevent complete closure and allow a minimum flow rate therethrough.

According to another aspect, each of the modules includes a second varistor in communication with the controller and positioned on a one of the plurality of thermal cooling channels therein.

According to another aspect, each varistor is adapted to generate a force signal in response to measured deformation, due to internal pressure increase, of the thermal cooling channel onto which the varistor is mounted.

According to another aspect, the inlet flow channel comprises a plurality of inlet flow channel segments, one inlet flow channel segment interconnecting the portion of the plurality of thermal cooling channels within each of the plurality of modules.

According to several aspects of the present disclosure, a method of detecting a thermal propagation event within a cooling system for a rechargeable battery pack, the cooling system including a plurality of thermal cooling channels adapted to be positioned between adjacent rows of individual battery cells of the battery pack, an inlet flow channel in fluid communication with each one of the plurality of thermal cooling channels and adapted to connect to a supply of coolant and provide a flow path between the supply of coolant and each one of the plurality of thermal cooling channels, an exit flow channel in fluid communication with each one of the plurality of thermal cooling channels and adapted to provide a flow path for coolant to exit each one of the plurality of thermal cooling channels, and a varistor, in communication with a controller, positioned on one of the plurality of thermal cooling channels, the method including generating, with the varistor, a force change signal in response to pressure increase within the one of the plurality of thermal cooling channels, communicating the force change signal to the controller, receiving, with the controller, the force change signal from the varistor, identifying, with the controller, the occurrence of battery cell venting and a thermal propagation event based on the force change signal, and altering, with the controller, flow of coolant through the plurality of thermal cooling channels in response to the identification of battery cell venting and the thermal propagation event.

According to another aspect, the plurality of thermal cooling channels is divided into a plurality of modules, each module including a portion of the plurality of thermal cooling channels positioned between adjacent structural cross-members of the battery pack, the cooling system including a plurality of varistors in communication with the controller, one of the plurality of varistors positioned on a one of the plurality of thermal cooling channels within each one of the modules, wherein the receiving, with the controller, the force change signal from the varistor, further including, receiving, with the controller, a force change signal from one of the plurality of varistors, the identifying, with the controller, the occurrence of battery cell venting and a thermal propagation event based on the force change signal, further including, identifying, with the controller, the occurrence of battery cell venting and a thermal propagation event within a one of the plurality of modules where the one of the plurality of varistors is positioned, and the altering, with the controller, flow of coolant through the plurality of thermal cooling channels in response to the identification of battery cell venting and the thermal propagation event, further including, increasing, with the controller, the flow of coolant through the thermal cooling channels of the one of the plurality of modules in response to the identification of battery cell venting and the thermal propagation event therein.

According to another aspect, the altering the flow of coolant through the plurality of thermal cooling channels by increasing the flow of coolant through the thermal cooling channels of the one of the plurality of modules, further includes, at least one of increasing the total flow of coolant within the coolant system, and diverting flow of coolant within the coolant system, selectively increasing the flow of coolant through the thermal cooling channels of the one of the plurality of modules and reducing the flow of coolant through remaining ones of the plurality of modules.

According to another aspect, the exit flow channel comprises a plurality of exit flow channel segments and a main exit channel, and wherein one exit flow channel segment interconnects the plurality of thermal cooling channels within each one of the modules, each exit flow channel segment including a vertical connector interconnecting the exit flow channel to the main exit channel, wherein, for each module, coolant flows from the plurality of thermal cooling channels into the exit flow channel segment and through the vertical connector upward to the main exit channel, the vertical connector of each of the plurality of exit flow channel segments including a selectively variable valve, wherein the cross-sectional area of a flow path of the vertical connector is selectively and independently variable, the selectively increasing the flow of coolant through the thermal cooling channels of the one of the plurality of modules and reducing the flow of coolant through the remaining ones of the plurality of modules, further including, at least one of actuating, with the controller, the selectively variable valve within the vertical connector of the exit flow channel segment within the one of the plurality of modules, and increasing the cross-sectional area of the flow path through the vertical connector, and actuating the selectively variable valve within the vertical connector of the exit flow channel segment within each of the remaining ones of the plurality of modules, and decreasing the cross-sectional area of the flow path therethrough.

According to another aspect, the actuating the selectively variable valve within the vertical connector of the exit flow channel segment within each of the remaining ones of the plurality of modules, and decreasing the cross-sectional area of the flow path therethrough, further includes preventing complete closure of each variable valve, and maintaining, at all times, a minimum flow rate through each variable valve.

According to another aspect, the receiving, with the controller, a force change signal from one of the plurality of varistors further includes receiving, with the controller, a force change signal from one of the plurality of varistors, wherein each of the modules includes a second varistor in communication with the controller and positioned on a one of the plurality of thermal cooling channels therein.

According to another aspect, the generating, with the varistor, a force change signal in response to pressure increase within the one of the plurality of thermal cooling channels further includes generating a force signal in response to measured deformation, due to internal pressure increase, of the thermal cooling channel onto which the varistor is mounted.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a vehicle having a battery pack and cooling system in accordance with an exemplary embodiment of the present disclosure;

FIG. 2 is a schematic view of a battery pack frame enclosure for the battery pack and cooling system in accordance with an exemplary embodiment;

FIG. 3 is a schematic view of the battery pack frame enclosure with the cooling system and a plurality of battery cells placed therein;

FIG. 4A is a schematic perspective view of the cooling system according to an exemplary embodiment of the present disclosure;

FIG. 4B is a schematic perspective view of the cooling system shown in FIG. 4A with a plurality of varistors positioned thereon;

FIG. 5A is an enlarged view of a portion of FIG. 4 as indicated by the circled portion of FIG. 4 labelled “FIG. 5A”;

FIG. 5B is a schematic view of the first U-hose connector shown in FIG. 5A, wherein the first U-hose connector is shown dis-assembled from the cooling system;

FIG. 6A is an enlarged view of a portion of FIG. 4 as indicated by the circled portion of FIG. 4 labelled “FIG. 6A”;

FIG. 6B is a schematic view of the second U-hose connector shown in FIG. 6A, wherein the second U-hose connector is shown dis-assembled from the cooling system;

FIG. 7 is a schematic exploded view of a first distal end of a first, second and third vertical connector;

FIG. 8 is an enlarged view of a portion of FIG. 4A as indicated by the circled portion of FIG. 4A labelled “FIG. 8”; and

FIG. 9 is flow chart illustrating a method according to an exemplary embodiment of the present disclosure.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and non-vehicle related consumer electronic components.

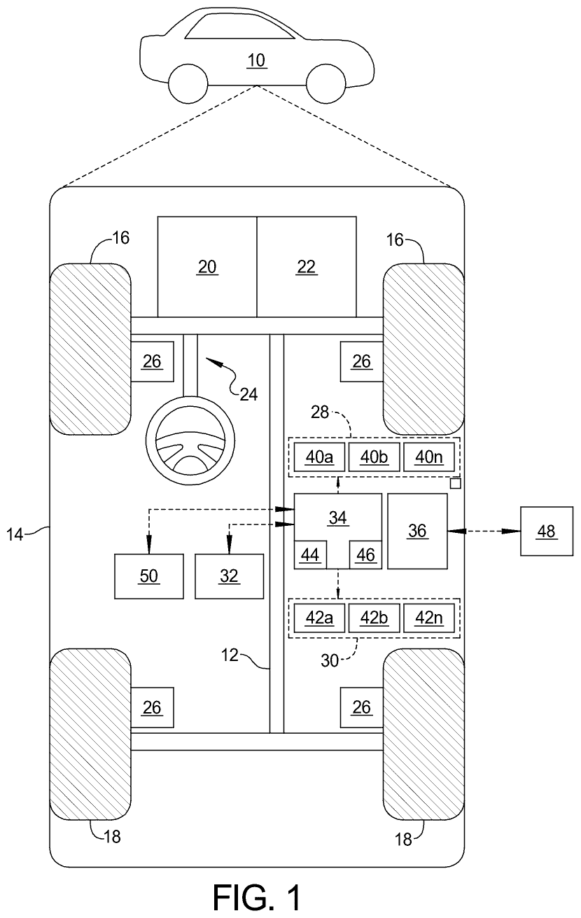

In accordance with an exemplary embodiment of the present disclosure, FIG. 1 shows a vehicle 10 with an associated battery pack 50 having a cooling system 52 in accordance with the present disclosure. In general, the battery pack 50 works in conjunction with other systems within the vehicle 10 to provide power to either or both an electric propulsion system 20 within the vehicle 10 and/or the various systems within the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to non-autonomous vehicles.

As shown, the vehicle 10 generally includes an electric propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, the electric propulsion system may include one or more electric motors that are connected to and powered by the battery pack 50, and there may be no transmission system 22. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, such as for a fully autonomous vehicle, the steering system 24 may not include a steering wheel.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, and/or other sensors. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

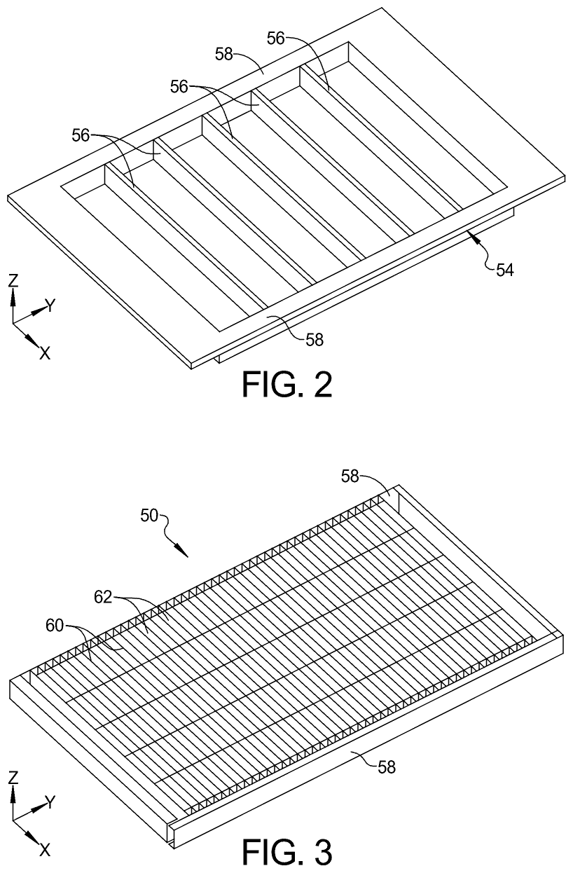

Referring to FIG. 2, a schematic perspective view of an example of a battery pack frame enclosure 54 for the electric vehicle 10 with five structural cross-members 56 that span across the entire width of the battery pack frame enclosure 54 along an X-direction is shown. Two frame enclosure structural side beams 58 run along the length of battery pack frame enclosure 54 in a Y-direction, which protects battery cells 60 of the battery pack 50. Referring to FIG. 3, the battery pack 50 includes a plurality of thermal cooling channels 62, or Super Beam assemblies, located in-between adjacent rows of battery cells 60 and oriented perpendicular to the frame enclosure side beams 58.

Details of the Super Beam assemblies, herein referred to as thermal cooling channels 62, are included in patent application Ser. No. 18/499,726 , entitled “Multi-Function Beam with Integrated Structural, Cooling, and Transverse Elastic Compliance Functions For Use with Electric Vehicle Battery Packs” and having a filing/371(c) date of Nov. 1, 2023, the entirety of which is hereby incorporated by reference into the present application.

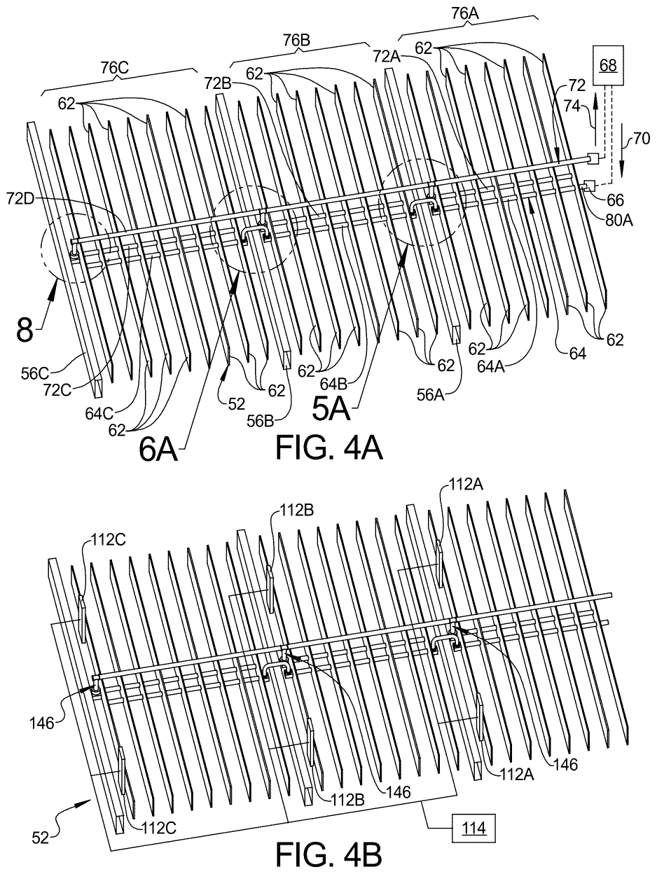

Referring to FIG. 4A, the cooling system 52 is shown wherein the rows of battery cells 60 between the plurality of thermal cooling channels 62 are removed. The cooling system 52 includes an inlet flow channel 64 in fluid communication with each one of the plurality of thermal cooling channels 62 and having a first distal end 80A with an inlet port 66 adapted to connect to a supply of coolant 68 and provide a flow path between the supply of coolant 68 and each one of the plurality of thermal cooling channels 62, as indicated by arrow 70. The cooling system 52 further includes an exit flow channel 72 in fluid communication with each one of the plurality of thermal cooling channels 62 and adapted to provide a flow path for coolant to exit each one of the plurality of thermal cooling channels 62 and return to the supply of coolant 68, as indicated by arrow 74.

The battery pack 50 and cooling system 52 is broken up into modules, wherein each module consists of a portion of the plurality of thermal cooling channels 62, and a portion of the battery cells 60 positioned therebetween, that are positioned between adjacent structural cross-members 56. As shown in FIG. 4A, the cooling system 52 includes a first module 76A adjacent a first structural cross-member 56A, a second module 76B between the first structural cross-member 56A and a second structural cross-member 56B, and a third module 76C between the second structural cross-member 56B and a third structural cross-member 56C. The example cooling system 52 shown in FIG. 4A is for illustrative purposes. It should be understood by those skilled in the art that the battery pack 50 and cooling system 52 may include any suitable number of structural cross-members 56 and corresponding modules.

Referring to FIG. 4B, the cooling system 52 includes a varistor 112, in communication with a controller 114, positioned on one of the plurality of thermal cooling channels 62. The varistor 112 is adapted to generate a force change signal in response to pressure increase within the one of the plurality of thermal cooling channels 62 onto which the varistor 112 is mounted and to communicate the force change signal to the controller 114. The varistor is adapted to generate a force signal in response to measured deformation of the thermal cooling channels 62 due to the internal pressure increase of the thermal cooling channel 62 onto which the varistor 112 is mounted. The temperature increase that causes this increase in pressure and deformation of the thermal cooling channel 62 is due to heat generated by the battery cells 60, possibly from a thermal propagation event.

Thermal propagation occurs due to a battery cell 60 failure of some kind, occasionally as simple as the separator between the anode and the electrolyte breaking down. The risk of thermal propagation begins at 60° C. and becomes extremely critical at 100° C. Once the process has begun, temperatures rise rapidly within milliseconds—creating temperatures of around 400-1000° C. It is particularly prevalent in lithium-ion batteries.

In an exemplary embodiment, the cooling system 52 includes a plurality of varistors 112 in communication with the controller 114, one of the plurality of varistors 112 positioned on a one of the plurality of thermal cooling channels 62 within each one of the first, second and third modules 76A, 76B, 76C. In another exemplary embodiment, each of the first, second and third modules 76A, 76B, 76C includes a two varistors 112 in communication with the controller 114 and positioned on a one of the plurality of thermal cooling channels 62 therein. The two varistors 112 within each module 76A, 76B, 76C may be mounted onto different ones of the plurality of thermal cooling channels 62 within the module 76A, 76B, 76C, or may be mounted onto the same one of the plurality of thermal cooling channels 62 within the module 76A, 76B, 76C. The second varistor 112 within each of the first, second and third modules 76A, 76B, 76C provides redundancy and a double check on what is happening within the thermal cooling channels 76 of the module 76A, 76B, 76C.

As shown in FIG. 4B, the cooling system 52 includes two varistors 112A mounted onto thermal cooling channels 62 within the first module 76A, two varistors 112B mounted onto thermal cooling channels 62 within the second module 76B, and two varistors 112C mounted onto thermal cooling channels 62 within the third module 76C. The controller 114 is adapted to receive a force change signal from at least one of the plurality of varistors 112A, 112B, 112C, identify the occurrence of battery cell venting and a thermal propagation event within the one of the plurality of modules 76A, 76B, 76C where the at least one of the plurality of varistors 112A, 112B, 112C is positioned, and alter flow of coolant through the plurality of thermal cooling channels 62 by increasing the flow of coolant through the thermal cooling channels 62 of the one of the plurality of modules 76A, 76B, 76C in response to the identification of battery cell venting and the thermal propagation event therein.

When a thermal propagation event takes place within a battery cell 60, the temperature will rise, increasing the temperature of the coolant within the thermal cooling channels 62 adjacent to the battery cell 60. Build up of temperature and gases within the battery cell 60 will eventually cause the battery cell to vent gases to the external environment. Deformation of the thermal cooling channels 62 adjacent to and near the battery cell 60 experiencing the thermal propagation event is measured by the varistors 112A, 112B, 112C, and converted to a force signal that is sent to the controller 114.

For example, if the controller receives a force change signal from one of the varistors 112B positioned in the second module 76B, the controller 114 will use that signal to identify the occurrence of cell venting and a thermal propagation event within the battery cells 60 of the second module 76B. Thus, in response, the controller 114 will increase the flow of coolant through the thermal cooling channels 62 of the second module 76B. In an exemplary embodiment, to increase the flow of coolant through the second module 76B, the controller 114 may increase the total flow of coolant within the cooling system 52, such as, by way of non-limiting example, increasing power of a pump adapted to supply coolant to the cooling system 52. In this instance, the flow of coolant is increased within all of the modules 76A, 76B, 76C within the cooling system 52. The increased flow of coolant will pull additional heat from the battery cells 60 within the battery pack 50 in all of the modules 76A, 76B, 76C, countering the thermal propagation event. In another exemplary embodiment, the controller 114 diverts flow of coolant within the coolant system 52, selectively increasing the flow of coolant through the thermal cooling channels 62 of the one of the plurality of modules 76A, 76B, 76C (the second module 76B in this example) and reducing the flow of coolant through remaining ones of the plurality of modules 76A, 76B, 76C (the first and third modules 76A, 76C in this example).

To allow the inlet flow channel 64 to extend across the structural cross members 56A, 56B, 56C without having to form a passage through the structural cross members 56A, 56B, 56C, the inlet flow channel 64 includes at least one U-hose connector 78A, 78B adapted to route the inlet flow channel 64 around a structural cross member 56 of the battery pack 50.

In an exemplary embodiment, the inlet flow channel 64 comprises a plurality of inlet flow channel segments 64A, 64B, 64C. A first U-hose connector 78A interconnects a first inlet flow channel segment 64A and a second inlet flow channel segment 64B, and a second U-hose connector 78B interconnects the second inlet flow channel segment 64B to a third inlet flow channel segment 64C.

The interconnection of the first inlet flow channel segment 64A to the second inlet flow channel segment 64B with the first U-hose connector 78A is substantially identical to the interconnection of the second inlet flow channel segment 64B to the third inlet flow channel segment 64C with the second U-hose connector 78B.

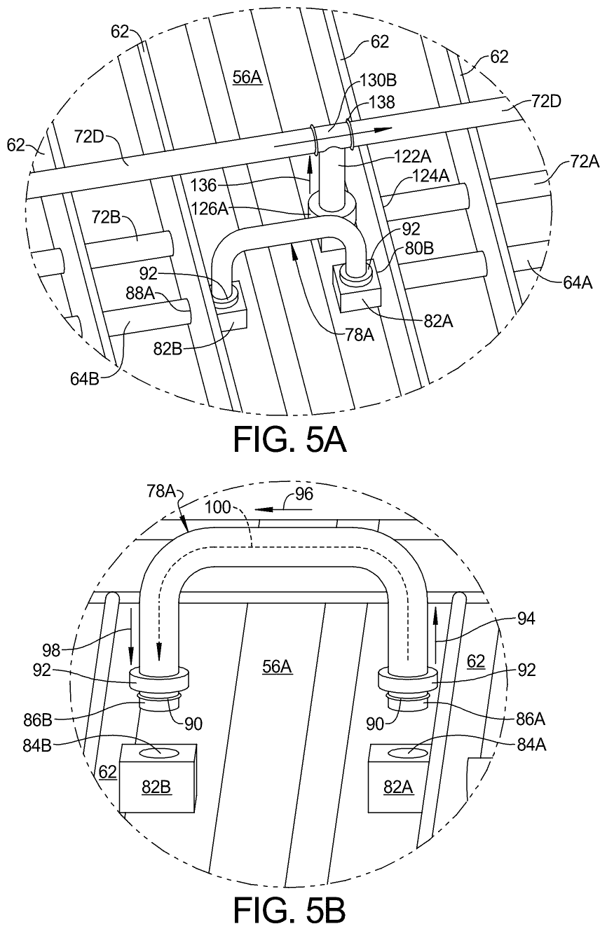

Referring to FIG. 5A and FIG. 5B, the first inlet flow channel segment 64A includes a second distal end 80B having a connection base 82A positioned thereon. The connection base 82A of the second distal end 80B of the first inlet flow channel 64A includes an upward facing orifice 84A adapted to receive a downward facing first distal end 86A of the first U-hose connector 78A. The second inlet flow channel segment 64B includes a first distal end 88A having a connection base 82B positioned thereon, the connection base 82B of the second inlet flow channel segment 64B including an upward facing orifice 84B adapted to receive a downward facing second distal end 86B of the first U-hose connector 78A. The first distal end 86A of the first U-hose connector 78A and the second distal end 86B of the first U-hose connector 78A each include an o-ring 90 adapted to create a fluid seal between the first U-hose connector 78A and the connection bases 82A, 82B.

Further, the first distal end 86A of the first U-hose connector 78A includes a hose fixture 92 mounted thereon and adapted to be secured to the connection base 82A of the first inlet flow channel segment 64A to secure the first distal end 86A of the first U-hose connector 78A within the orifice 84A of the connection base 82A of the first inlet flow channel segment 64A, and the second distal end 86B of the first U-hose connector 78A includes a hose fixture 92 mounted thereon and adapted to be secured to the connection base 82B of at the first distal end 88A of the second inlet flow channel segment 64B to secure the second distal end 86B of the first U-hose connector 78A within the orifice 84B of the connection base 82B of the second inlet flow channel segment 64B. In an exemplary embodiment, the hose fixtures 92 are secured to the connection bases 82A, 82B with a threaded fastener (not shown).

The first U-hose connector 78A has a shape extending upward from the connection base 82A of the first inlet flow channel segment 64A, as indicated by arrow 94, laterally over the first structural cross-member 56A of the battery pack 50, as indicated by arrow 96, and downward to the connection base 82B of the second inlet flow channel segment 64B, as indicated by arrow 98, defining a flow path 100 interconnecting the first inlet flow channel segment 64A to the second inlet flow channel segment 64B.

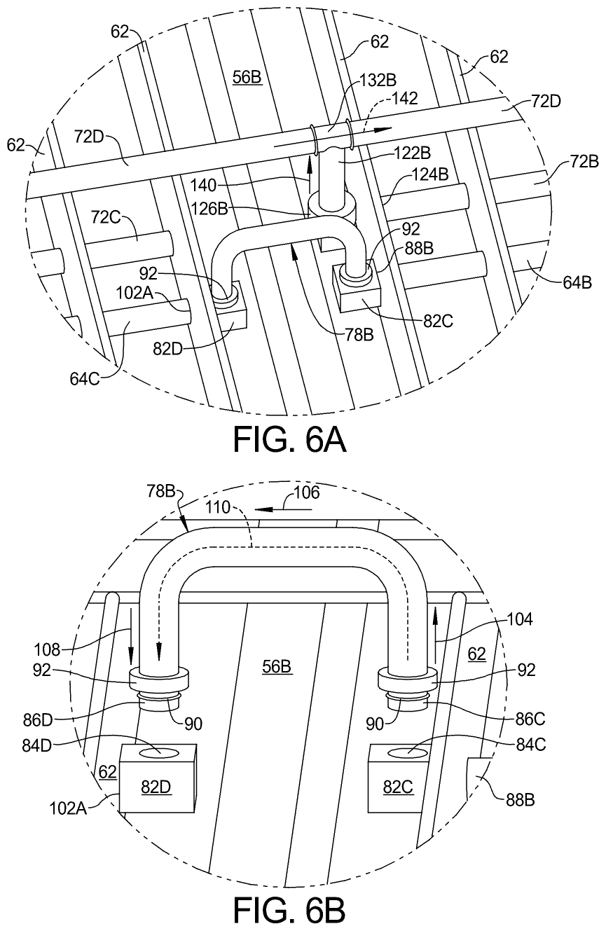

Referring to FIG. 6A and FIG. 6B, the second inlet flow channel segment 64B includes a second distal end 88B having a connection base 82C positioned thereon. The connection base 82C of the second distal end 88B of the second inlet flow channel 64B includes an upward facing orifice 84C adapted to receive a downward facing first distal end 86C of the second U-hose connector 78B. The third inlet flow channel segment 64C includes a first distal end 102A having a connection base 82D positioned thereon, the connection base 82D of the first distal end 102A of the third inlet flow channel segment 64C including an upward facing orifice 84D adapted to receive a downward facing second distal end 86D of the second U-hose connector 78B. The first distal end 86C of the second U-hose connector 78B and the second distal end 86D of the second U-hose connector 78B each include an o-ring 90 adapted to create a fluid seal between the second U-hose connector 78B and the connection bases 82C, 82D.

Further, the first distal end 86C of the second U-hose connector 78B includes a hose fixture 92 mounted thereon and adapted to be secured to the connection base 82C of the second distal end 88B of the second inlet flow channel segment 64B to secure the first distal end 86C of the second U-hose connector 78B within the orifice 84C of the connection base 82C of the second distal end 88B of the second inlet flow channel segment 64B, and the second distal end 86D of the second U-hose connector 78B includes a hose fixture 92 mounted thereon and adapted to be secured to the connection base 82D at the first distal end 102A of the third inlet flow channel segment 64C to secure the second distal end 86D of the second U-hose connector 78B within the orifice 84D of the connection base 82D of the first distal end 102A of the third inlet flow channel segment 64C. In an exemplary embodiment, the hose fixtures 92 are secured to the connection bases 82C, 82D with a threaded fastener (not shown).

The second U-hose connector 78B has a shape extending upward from the connection base 82C at the second distal end 88B of the second inlet flow channel segment 64B, as indicated by arrow 104, laterally over the second structural cross-member 56B of the battery pack 50, as indicated by arrow 106, and downward to the connection base 82D at the first distal end 102A of the third inlet flow channel segment 64C, as indicated by arrow 108, defining a flow path 110 interconnecting the second inlet flow channel segment 64B to the third inlet flow channel segment 64C.

In an exemplary embodiment, the exit flow channel 72 comprises a plurality of exit flow channel segments 72A, 72B, 72C and a main exit channel 72D. A first exit flow channel segment 72A is in fluid communication with the thermal cooling channels 62 of the first module 76A, a second exit flow channel segment 72B is in fluid communication with the thermal cooling channels 62 of the second module 76B, and a third exit flow channel segment 72C is in fluid communication with the thermal cooling channels 62 of the third module 76C. A first vertical connector 122A interconnects the first exit flow channel segment 72A and the main exit channel 72D, a second vertical connector 122B interconnects the second exit flow channel segment 72B to the main exit channel 72D, and a third vertical connector 122C interconnects the third exit flow channel segment 72C to the main exit channel 72D.

The main exit channel 72D extends laterally over the plurality of thermal cooling channels 62 and structural cross members 56A, 56B, 56C of the battery pack 50. Coolant flows from the plurality of thermal cooling channels 62 within the first module 76A into the first exit flow channel segment 72A and through the first vertical connector 122A to the main exit channel 72D and back to the source of coolant 68. Coolant flows from the plurality of thermal cooling channels 62 within the second module 76B into the second exit flow channel segment 72B and through the second vertical connector 122B to the main exit channel 72D and back to the source of coolant 68. Coolant flows from the plurality of thermal cooling channels 62 within the third module 76C into the second exit flow channel segment 72C and through the third vertical connector 122C to the main exit channel 72D and back to the source of coolant 68.

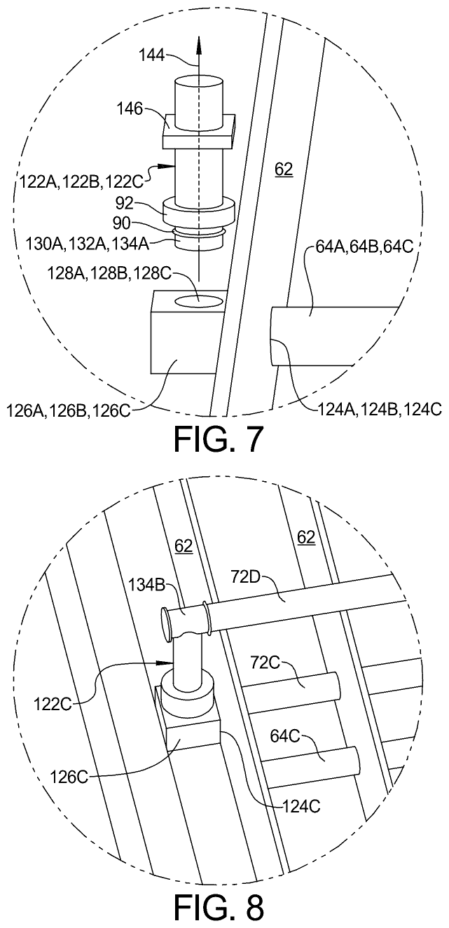

Referring to FIG. 5A and FIG. 7, the first exit flow channel segment 72A includes a distal end 124A having a connection base 126A positioned thereon and including an upward facing orifice 128A, wherein a downward facing first distal end 130A of the first vertical connector is received within the upward facing orifice 128A of the connection base 126A at the distal end 124A of the first exit flow channel segment 72A. The first distal end 130A of the first vertical connector 122A includes an o-ring 90 adapted to create a fluid seal between the first vertical connector 122A and the connection base 126A at the distal end 124A of the first exit flow channel segment 72A.

Further, the first distal end 130A of the first vertical connector 122A includes a hose fixture 92 mounted thereon and adapted to be secured to the connection base 126A of the distal end 124A of the first exit flow channel segment 72A to secure the first distal end 130A of the first vertical connector 122A within the orifice 128A of the connection base 126A at the distal end 124A of the first exit flow channel segment 72A. In an exemplary embodiment, the hose fixture 92 is secured to the connection base 126A with a threaded fastener (not shown).

Referring to FIG. 6A and FIG. 7, the second exit flow channel segment 72B includes a distal end 124B having a connection base 126B positioned thereon and including an upward facing orifice 128B, wherein a downward facing first distal end 132A of the second vertical connector 122B is received within the upward facing orifice 128B of the connection base 126B at the distal end 124B of the second exit flow channel segment 72B. The first distal end 132A of the second vertical connector 122B includes an o-ring 90 adapted to create a fluid seal between the second vertical connector 122B and the connection base 126B at the distal end 124B of the second exit flow channel segment 72B.

Further, the first distal end 132A of the second vertical connector 122B includes a hose fixture 92 mounted thereon and adapted to be secured to the connection base 126B of the distal end 124B of the second exit flow channel segment 72B to secure the first distal end 132A of the second vertical connector 122B within the orifice 128B of the connection base 126B at the distal end 124B of the second exit flow channel segment 72B. In an exemplary embodiment, the hose fixture 92 is secured to the connection base 126B with a threaded fastener (not shown).

Referring to FIG. 7 and FIG. 8, the third exit flow channel segment 72C includes a distal end 124C having a connection base 126C positioned thereon and including an upward facing orifice 128C, wherein a downward facing first distal end 134A of the third vertical connector 122C is received within the upward facing orifice 128C of the connection base 126C at the distal end 124C of the third exit flow channel segment 72C. The first distal end 134A of the third vertical connector 122C includes an o-ring 90 adapted to create a fluid seal between the third vertical connector 122C and the connection base 126C at the distal end 124C of the third exit flow channel segment 72C.

Further, the first distal end 134A of the third vertical connector 122C includes a hose fixture 92 mounted thereon and adapted to be secured to the connection base 126C of the distal end 124C of the third exit flow channel segment 72C to secure the first distal end 134A of the third vertical connector 122C within the orifice 128C of the connection base 126C at the distal end 124C of the third exit flow channel segment 72C. In an exemplary embodiment, the hose fixture 92 is secured to the connection base 126C with a threaded fastener (not shown).

Referring again to FIG. 5A, a second distal end 130B of the first vertical connector 122A is in fluid communication with the main exit channel 72D via a T-connection, wherein coolant flows through the second distal end 130B of the first vertical connector 122A from the first exit flow channel segment 72A, as indicated by arrow 136, and from the second and third exit flow channels 122B, 122C, as indicated by arrow 138. Referring again to FIG. 6A, a second distal end 132B of the second vertical connector 122B is in fluid communication with the main exit channel 72D via a T-connection, wherein coolant flows through the second distal end 132B of the second vertical connector 122B from the second exit flow channel segment 72B, as indicated by arrow 140, and from the third exit flow channel 122C, as indicated by arrow 142. Referring again to FIG. 8, a second distal end 134B of the third vertical connector 122C is in fluid communication with the main exit channel 72D via an L-connection, wherein coolant flows through the second distal end 134B of the third vertical connector 122C from the third exit flow channel segment 72C, as indicated by arrow 144.

In an exemplary embodiment, referring again to FIG. 7, for each of the first, second and third exit flow channels 72A, 72B, 72C, the vertical connector 122A, 122B, 122C defines a flow path 144 from the connection base 126A, 126B, 126C of the exit flow channel segment 72A, 72B, 72C to the main exit channel 72D. The vertical connector 122A, 122B, 122C of each of the plurality of exit flow channel segments 72A, 72B, 72C includes a selectively variable valve 146, wherein the cross-sectional area (effective diameter of a circular flow path) of the flow path 144 of the vertical connector 122A, 122B, 122C is selectively and independently variable. In simplest terms, generally the cross-sectional area of the flow path of the first vertical connector 122A is smaller than the cross-sectional area of the flow path of the second vertical connector 122B, which is smaller than the cross-sectional area of the flow path of the third vertical connector 122C, due to the respective distances of each of the first, second and third vertical connectors 122A, 122B, 122C from the inlet port 66. The selectively variable valve 146 within each vertical connector 122A, 122B, 122C allows the cooling system 52 to maintain a balanced flow from all the modules 76A, 76B, 76C under variable conditions.

Further, when the controller 114 receives a force change signal from one of the varistors 112A, 112B, 112C, the controller 114 uses the variable valves 146 to alter the flow of coolant within the cooling system 52. Rather than maintaining a balanced flow, the controller 114, using the variable valves 146 of the vertical connectors 122A, 122B, 122C, alters the flow of coolant, allowing more coolant to flow within the module 76A, 76B, 76C wherein a thermal propagation event is identified. Referring again to the example cited above, the controller 114 receives a force change signal from one of the varistors 112B positioned within the second module 76B. Thus, in response, the controller 114 will increase the flow of coolant through the thermal cooling channels 62 of the second module 76B. To do this, the controller 114 actuates the selectively variable valve 146 within the vertical connector 122B of the second exit flow channel segment 72B within the second module 76B, increasing the cross-sectional area of the flow path 144 through the second vertical connector 122B and allowing more coolant to flow through the thermal cooling channels 62 of the second module 76B. Additionally, the controller 114 may also actuate the selectively variable valves 146 within the vertical connectors 122A, 122C of the first and third exit flow channel segments 72A, 72C within each of the remaining ones of the plurality of modules 76A, 76B, 76C (the first and third modules 76A, 76C in this example), to decrease the cross-sectional area of the flow path 144 within each of the vertical connectors 122A, 122C of the first and third exit flow channel segments 72A, 72C, reducing the coolant flow through the thermal cooling channels 62 of the first and third modules 76A, 76C.

In an exemplary embodiment, each selectively variable valve 146 is adapted to prevent complete closure and allow a minimum flow rate therethrough. Thus, in all circumstances, the cooling system 52 cannot completely deprive any of the modules 76A, 76B, 76C from coolant flow, ensuring that proper cooling is provided to all modules 76A, 76B, 76C even when measures are being taken to provide additional cooling to a module 76A, 76B, 76C wherein a thermal propagation event is detected.

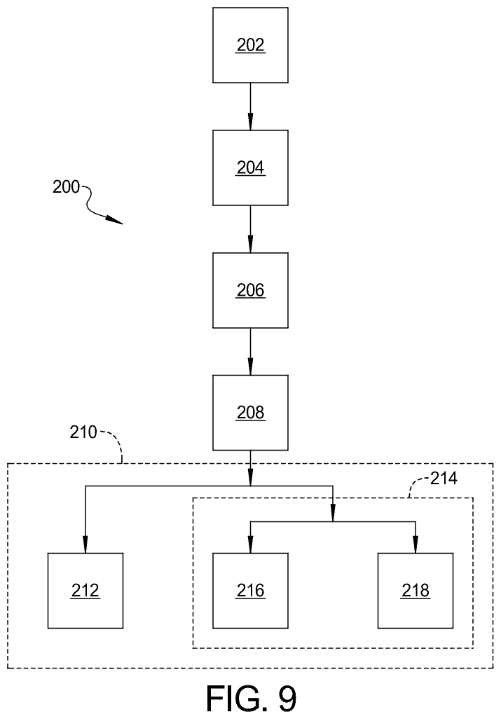

Referring to FIG. 9, a method 200 of detecting a thermal propagation event within a cooling system 52 for a rechargeable battery pack 50, wherein the cooling system 52 includes a plurality of thermal cooling channels 62 adapted to be positioned between adjacent rows of individual battery cells 60 of the battery pack 50, an inlet flow channel 64 in fluid communication with each one of the plurality of thermal cooling channels 62 and adapted to connect to a supply of coolant 68 and provide a flow path between the supply of coolant 68 and each one of the plurality of thermal cooling channels 62, an exit flow channel 72 in fluid communication with each one of the plurality of thermal cooling channels 62 and adapted to provide a flow path for coolant to exit each one of the plurality of thermal cooling channels 62, and a varistor 112, in communication with a controller 114, positioned on one of the plurality of thermal cooling channels 62, the method 200 including, beginning at block 202, generating, with the varistor 112, a force change signal in response to pressure increase within the one of the plurality of thermal cooling channels 62, moving to block 204, communicating the force change signal to the controller 114, moving to block 206, receiving, with the controller 114, the force change signal from the varistor 112, moving to block 208, identifying, with the controller 114, the occurrence of battery cell venting and a thermal propagation event based on the force change signal, and, moving to block 210, altering, with the controller 114, flow of coolant through the plurality of thermal cooling channels 62 in response to the identification of battery cell venting and the thermal propagation event.

In an exemplary embodiment, wherein the plurality of thermal cooling channels 62 is divided into a plurality of modules 76A, 76B, 76C, each module 76A, 76B, 76C including a portion of the plurality of thermal cooling channels 62 positioned between adjacent structural cross-members 56A, 56B, 56C of the battery pack 50, the cooling system 52 including a plurality of varistors 112A, 112B, 112C in communication with the controller 114, one of the plurality of varistors 112A, 112B, 112C positioned on a one of the plurality of thermal cooling channels 62 within each one of the modules 76A, 76B, 76C, wherein, the receiving, with the controller 114, the force change signal from the varistor 112 at block 206, further includes, receiving, with the controller 114, a force change signal from one of the plurality of varistors 112A, 112B, 112C, the identifying, with the controller 114, the occurrence of battery cell venting and a thermal propagation event based on the force change signal at block 208, further includes, identifying, with the controller 114, the occurrence of battery cell venting and a thermal propagation event within a one of the plurality of modules 76A, 76B, 76C where the one of the plurality of varistors 112A, 112B, 112C is positioned, and, the altering, with the controller 114, flow of coolant through the plurality of thermal cooling channels 62 in response to the identification of battery cell venting and the thermal propagation event at block 210, further includes, increasing, with the controller 114, the flow of coolant through the thermal cooling channels 62 of the one of the plurality of modules 76A, 76B, 76C in response to the identification of battery cell venting and the thermal propagation event therein by at least one of, moving to block 212, increasing the total flow of coolant within the coolant system 52, and, moving to block 214, diverting flow of coolant within the coolant system 52, selectively increasing the flow of coolant through the thermal cooling channels 62 of the one of the plurality of modules 76A, 76B, 76C and reducing the flow of coolant through remaining ones of the plurality of modules 76A, 76B, 76C.

In another exemplary embodiment, wherein the exit flow channel 72 comprises a plurality of exit flow channel segments 72A, 72B, 72C and a main exit channel 72D, and wherein one exit flow channel segment 72A, 72B, 72C interconnects the plurality of thermal cooling channels 62 within each one of the modules 76A, 76B, 76C, each exit flow channel segment 72A, 72B, 72C including a vertical connector 122A, 122B, 122C interconnecting the exit flow channel segment 72A, 72B, 72C to the main exit channel 72D, wherein, for each module 76A, 76B, 76C, coolant flows from the plurality of thermal cooling channels 62 into the exit flow channel segment 72A, 72B, 72C and through the vertical connector 122A, 122B, 122C upward to the main exit channel 72D, the vertical connector 122A, 122B, 122C of each of the plurality of exit flow channel segments 72A, 72B, 72C including a selectively variable valve 146, wherein the cross-sectional area of a flow path 144 of the vertical connector 122A, 122B, 122C is selectively and independently variable, and, the selectively increasing the flow of coolant through the thermal cooling channels 62 of the one of the plurality of modules 76A, 76B, 76C and reducing the flow of coolant through the remaining ones of the plurality of modules 76A, 76B, 76C at block 214 further including at least one of, moving to block 216, actuating, with the controller 114, the selectively variable valve 146 within the vertical connector 122A, 122B, 122C of the exit flow channel segment 72A, 72B, 72C within the one of the plurality of modules 76A, 76B, 76C, and increasing the cross-sectional area of the flow path 144 through the vertical connector 122A, 122B, 122C, and, moving to block 218, actuating the selectively variable valve 146 within the vertical connector 122A, 122B, 122C of the exit flow channel segment 72A, 72B, 72C within each of the remaining ones of the plurality of modules 76A, 76B, 76D, and decreasing the cross-sectional area of the flow path 144 therethrough.

In another exemplary embodiment, the actuating the selectively variable valve 146 within the vertical connector 122A, 122B, 122C of the exit flow channel segment 72A, 72B, 72C within each of the remaining ones of the plurality of modules 76A, 76B, 76C, and decreasing the cross-sectional area of the flow path 144 therethrough at block 218, further includes preventing complete closure of each variable valve 146, and maintaining, at all times, a minimum flow rate through each variable valve 146.

In another exemplary embodiment, the receiving, with the controller 114, a force change signal from one of the plurality of varistors 112 at block 206 further includes receiving, with the controller 114, a force change signal from one of the plurality of varistors 112, wherein each of the modules 76A, 76B, 76C includes a second varistor 112 in communication with the controller 114 and positioned on a one of the plurality of thermal cooling channels 62 therein.

In another exemplary embodiment, the generating, with the varistor 112, a force change signal in response to pressure increase within the one of the plurality of thermal cooling channels 62 at block 202 further includes generating a force signal in response to measured deformation, due to internal pressure increase, of the thermal cooling channel 62 onto which the varistor 112 is mounted.

The cooling system 52 and method 200 of the present disclosure offers the advantage of providing reliable early detection and remedial action in response to a thermal propagation event within a battery pack 50. Other methods of detecting thermal propagation using temperature sensors or pressure sensors have inherent delays that prevent such methods from providing indication of a thermal propagation event soon enough to allow meaningful remedial action to alleviate the thermal propagation event. Using varistors 112 allows the cooling system 52 of the present disclosure to detect deformation of the battery cell 60 and the thermal cooling channels 62 within the cooling system 52 and generate a force signal in response to pressure build up within the battery cell 60 and the occurrence of venting of the battery cell 60. Upon occurrence of a thermal propagation event a significant drop in the voltage of the battery cell 60 is observed. However, deformation of the battery cell 60 and thermal cooling channel 62 and venting of the battery cell 60 occurs before this happens. Thus, the cooling system 52 and method 200 of the present disclosure allows detection and identification of a thermal propagation event prior to the measurable voltage drop that occurs with the thermal propagation event. This allows the cooling system 52 to take remedial action by altering the flow of coolant therein to provide increased coolant flow in the thermal cooling channels 62 within the module 76A, 76B, 76C where the battery cell 60 experiencing the thermal propagation event is located. The cooling system 52 and method 200 of the present disclosure provides proactive identification of and response to a thermal propagation event.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A cooling system for a rechargeable battery pack, comprising:
a plurality of thermal cooling channels adapted to be positioned between adjacent rows of individual battery cells of the battery pack;
an inlet flow channel in fluid communication with each one of the plurality of thermal cooling channels and adapted to connect to a supply of coolant and provide a flow path between the supply of coolant and each one of the plurality of thermal cooling channels;
an exit flow channel in fluid communication with each one of the plurality of thermal cooling channels and adapted to provide a flow path for coolant to exit each one of the plurality of thermal cooling channels; and
a varistor, in communication with a controller, positioned on one of the plurality of thermal cooling channels and adapted to generate a force change signal in response to pressure increase within the one of the plurality of thermal cooling channels and to communicate the force change signal to the controller;
the controller adapted to:
receive the force change signal from the varistor;
identify the occurrence of battery cell venting and a thermal propagation event based on the force change signal; and
alter flow of coolant through the plurality of thermal cooling channels in response to the identification of battery cell venting and the thermal propagation event.

2. The cooling system of claim 1, wherein the plurality of thermal cooling channels is divided into a plurality of modules, each module including a portion of the plurality of thermal cooling channels positioned between adjacent structural cross-members of the battery pack;
the cooling system including a plurality of varistors in communication with the controller, one of the plurality of varistors positioned on a one of the plurality of thermal cooling channels within each one of the modules.

3. The cooling system of claim 2, wherein the controller is further adapted to:
receive a force change signal from one of the plurality of varistors;
identify the occurrence of battery cell venting and a thermal propagation event within a one of the plurality of modules where the one of the plurality of varistors is positioned; and
alter flow of coolant through the plurality of thermal cooling channels by increasing the flow of coolant through the thermal cooling channels of the one of the plurality of modules in response to the identification of battery cell venting and the thermal propagation event therein.

4. The cooling system of claim 3, wherein when altering the flow of coolant through the plurality of thermal cooling channels by increasing the flow of coolant through the thermal cooling channels of the one of the plurality of modules, the controller is adapted to at least one of:
increase total flow of coolant within the coolant system; and
divert flow of coolant within the coolant system, selectively increasing the flow of coolant through the thermal cooling channels of the one of the plurality of modules and reducing the flow of coolant through remaining ones of the plurality of modules.

5. The cooling system of claim 4, wherein the exit flow channel comprises a plurality of exit flow channel segments and a main exit channel, and wherein:
one exit flow channel segment interconnects the plurality of thermal cooling channels within each one of the modules, each exit flow channel segment including a vertical connector interconnecting the exit flow channel to the main exit channel, wherein, for each module, coolant flows from the plurality of thermal cooling channels into the exit flow channel segment and through the vertical connector upward to the main exit channel;
the vertical connector of each of the plurality of exit flow channel segments including a selectively variable valve, wherein the cross-sectional area of a flow path of the vertical connector is selectively and independently variable.

6. The cooling system of claim 5, wherein when selectively increasing the flow of coolant through the thermal cooling channels of the one of the plurality of modules and reducing the flow of coolant through the remaining ones of the plurality of modules, the controller is adapted to at least one of:
actuate the selectively variable valve within the vertical connector of the exit flow channel segment within the one of the plurality of modules, increasing the cross-sectional area of the flow path through the vertical connector; and
actuate the selectively variable valve within the vertical connector of the exit flow channel segment within each of the remaining ones of the plurality of modules, decreasing the cross-sectional area of the flow path.

7. The cooling system of claim 6, wherein each variable valve is adapted to prevent complete closure and allow a minimum flow rate therethrough.

8. The cooling system of claim 6, wherein each of the modules includes a second varistor in communication with the controller and positioned on a one of the plurality of thermal cooling channels therein.

9. The cooling system of claim 6, wherein each varistor is adapted to generate a force signal in response to measured deformation, due to internal pressure increase, of the thermal cooling channel onto which the varistor is mounted.

10. The cooling system of claim 6, wherein the inlet flow channel comprises a plurality of inlet flow channel segments, one inlet flow channel segment interconnecting the portion of the plurality of thermal cooling channels within each of the plurality of modules.

11. A method of detecting a thermal propagation event within a cooling system for a rechargeable battery pack, the cooling system including:
a plurality of thermal cooling channels adapted to be positioned between adjacent rows of individual battery cells of the battery pack;
an inlet flow channel in fluid communication with each one of the plurality of thermal cooling channels and adapted to connect to a supply of coolant and provide a flow path between the supply of coolant and each one of the plurality of thermal cooling channels;
an exit flow channel in fluid communication with each one of the plurality of thermal cooling channels and adapted to provide a flow path for coolant to exit each one of the plurality of thermal cooling channels; and
a varistor, in communication with a controller, positioned on one of the plurality of thermal cooling channels;
the method including:
generating, with the varistor, a force change signal in response to pressure increase within the one of the plurality of thermal cooling channels;
communicating the force change signal to the controller;
receiving, with the controller, the force change signal from the varistor;
identifying, with the controller, the occurrence of battery cell venting and a thermal propagation event based on the force change signal; and
altering, with the controller, flow of coolant through the plurality of thermal cooling channels in response to the identification of battery cell venting and the thermal propagation event.

12. The method of claim 11, wherein the plurality of thermal cooling channels is divided into a plurality of modules, each module including a portion of the plurality of thermal cooling channels positioned between adjacent structural cross-members of the battery pack, the cooling system including a plurality of varistors in communication with the controller, one of the plurality of varistors positioned on a one of the plurality of thermal cooling channels within each one of the modules, wherein:
the receiving, with the controller, the force change signal from the varistor, further including, receiving, with the controller, a force change signal from one of the plurality of varistors;
the identifying, with the controller, the occurrence of battery cell venting and a thermal propagation event based on the force change signal, further including, identifying, with the controller, the occurrence of battery cell venting and a thermal propagation event within a one of the plurality of modules where the one of the plurality of varistors is positioned; and
the altering, with the controller, flow of coolant through the plurality of thermal cooling channels in response to the identification of battery cell venting and the thermal propagation event, further including, increasing, with the controller, the flow of coolant through the thermal cooling channels of the one of the plurality of modules in response to the identification of battery cell venting and the thermal propagation event therein.

13. The method of claim 12, wherein the altering the flow of coolant through the plurality of thermal cooling channels by increasing the flow of coolant through the thermal cooling channels of the one of the plurality of modules, further includes, at least one of:
increasing the total flow of coolant within the coolant system; and
diverting flow of coolant within the coolant system, selectively increasing the flow of coolant through the thermal cooling channels of the one of the plurality of modules and reducing the flow of coolant through remaining ones of the plurality of modules.

14. The method of claim 13, wherein the exit flow channel comprises a plurality of exit flow channel segments and a main exit channel, and wherein:
one exit flow channel segment interconnects the plurality of thermal cooling channels within each one of the modules, each exit flow channel segment including a vertical connector interconnecting the exit flow channel to the main exit channel, wherein, for each module, coolant flows from the plurality of thermal cooling channels into the exit flow channel segment and through the vertical connector upward to the main exit channel, the vertical connector of each of the plurality of exit flow channel segments including a selectively variable valve, wherein the cross-sectional area of a flow path of the vertical connector is selectively and independently variable;
the selectively increasing the flow of coolant through the thermal cooling channels of the one of the plurality of modules and reducing the flow of coolant through the remaining ones of the plurality of modules, further including, at least one of:
actuating, with the controller, the selectively variable valve within the vertical connector of the exit flow channel segment within the one of the plurality of modules, and increasing the cross-sectional area of the flow path through the vertical connector; and
actuating the selectively variable valve within the vertical connector of the exit flow channel segment within each of the remaining ones of the plurality of modules, and decreasing the cross-sectional area of the flow path therethrough.

15. The method of claim 14, wherein the actuating the selectively variable valve within the vertical connector of the exit flow channel segment within each of the remaining ones of the plurality of modules, and decreasing the cross-sectional area of the flow path therethrough, further includes:
preventing complete closure of each variable valve; and
maintaining, at all times, a minimum flow rate through each variable valve.

16. The method of claim 15, wherein the receiving, with the controller, a force change signal from one of the plurality of varistors further includes receiving, with the controller, a force change signal from one of the plurality of varistors, wherein each of the modules includes a second varistor in communication with the controller and positioned on a one of the plurality of thermal cooling channels therein.

17. The method of claim 16, wherein the generating, with the varistor, a force change signal in response to pressure increase within the one of the plurality of thermal cooling channels further includes generating a force signal in response to measured deformation, due to internal pressure increase, of the thermal cooling channel onto which the varistor is mounted.

18. An electric vehicle having a rechargeable battery pack, comprising:
a plurality of battery cells; and
a cooling system for cooling the battery cells, the cooling system including:
a plurality of modules, each module including a plurality of thermal cooling channels adapted to be positioned between adjacent rows of individual battery cells of the battery pack, each module being positioned between adjacent structural cross-members of the battery pack;
an inlet flow channel in fluid communication with each one of the plurality of thermal cooling channels of each module and adapted to connect to a supply of coolant and provide a flow path between the supply of coolant and each one of the plurality of thermal cooling channels within each module;
an exit flow channel in fluid communication with each one of the plurality of thermal cooling channels within each module and adapted to provide a flow path for coolant to exit each one of the plurality of thermal cooling channels; and
a plurality of varistors, in communication with a controller, two varistors positioned within each module, each varistor mounted onto a one of the plurality of thermal cooling channels therein, each varistor adapted to generate a force change signal in response to measured deformation, due to internal pressure increase, within the one of the plurality of thermal cooling channels onto which the varistor is mounted and to communicate the force change signal to the controller;
the controller adapted to:
receive a force change signal from at least one of the plurality of varistors;
identify the occurrence of battery cell venting and a thermal propagation event within a one of the plurality of modules where the at least one of the plurality of varistors is positioned; and
alter flow of coolant through the plurality of thermal cooling channels by increasing the flow of coolant through the thermal cooling channels of the one of the plurality of modules in response to the identification of battery cell venting and the thermal propagation event therein by at least one of:
increasing total flow of coolant within the coolant system; and
diverting flow of coolant within the coolant system, selectively increasing the flow of coolant through the thermal cooling channels of the one of the plurality of modules and reducing the flow of coolant through remaining ones of the plurality of modules.

19. The electric vehicle of claim 18, wherein the exit flow channel comprises a plurality of exit flow channel segments and a main exit channel, and wherein:
one exit flow channel segment interconnects the plurality of thermal cooling channels within each one of the modules, each exit flow channel segment including a vertical connector interconnecting the exit flow channel to the main exit channel, wherein, for each module, coolant flows from the plurality of thermal cooling channels into the exit flow channel segment and through the vertical connector upward to the main exit channel;
the vertical connector of each of the plurality of exit flow channel segments including a selectively variable valve, wherein the cross-sectional area of a flow path of the vertical connector is selectively and independently variable;
wherein when selectively increasing the flow of coolant through the thermal cooling channels of the one of the plurality of modules and reducing the flow of coolant through the remaining ones of the plurality of modules, the controller is adapted to at least one of:
actuate the selectively variable valve within the vertical connector of the exit flow channel segment within the one of the plurality of modules, increasing the cross-sectional area of the flow path through the vertical connector; and
actuate the selectively variable valve within the vertical connector of the exit flow channel segment within each of the remaining ones of the plurality of modules, decreasing the cross-sectional area of the flow path.

20. The electric vehicle of claim 19, wherein each variable valve is adapted to prevent complete closure and allow a minimum flow rate therethrough.
